(19) United States
(12) Patent Application Publication
(10) Pub. No.: US 2022/0273970 A1
(43) Pub. Date: Sep. 1, 2022

(54) A MASK

(71) Applicant: Marc BARNFATHER, Pringle (ZA)

(72) Inventor: Marc BARNFATHER, Pringle Bay (ZA)

(73) Assignee: Marc BARNFATHER, Pringle Bay (ZA)

(21) Appl. No.: 17/632,450

(22) PCT Filed: Jun. 11, 2021
(86) PCT No.: PCT/IB2021/055167

§ 371 Date: Feb. 2, 2022

(30) Foreign Application Priority Data
Jun. 22, 2020 (ZA) 2020/03737

(51) Int. Cl. A62B 23/02; A41D 13/11

(52) U.S. Cl. CPC A62B 23/025; A41D 13/1107

(57) ABSTRACT

The invention provides for a mask having at least two compartments, each compartment being in flow communication with either the nose or mouth of a user.

### BACK GROUND TO THE INVENTION

The present invention relates to a mask.

In the current covid 19 pandemic, society requires that social distancing be adhere to at all times in order to limit the spread of a typical virus such as Covid 19.

However, it will be appreciate that social distancing will be required in any instance where the spread of a highly contagious virus need to be limited. Furthermore, it will also be appreciated that the use of a mask, as described in this invention, find many applications and may be utilised to prevent and limit injury to a user, for example, in polluted areas.

In many instances, social distancing is just not possible and are the boundaries of social distancing breached. In other instances, a user has not alternative but to endure a polluted area.

In the event that social distancing is not possible, in the event of a virus such as covid19, alternatively in the event that a user is required to function in a polluted area, the only manner in which any injury or risk of a user can be limited or prevented, is by wearing protective equipment such as masks and shields. This is especially important when a highly contagious virus is airborne.

Various application and designs relating to masks and shields are available in the market. However, a problem generally associated with these designs is that the CO2 exhaled by the user is not sufficiently displaced, resulting in the user inhaling CO2. This may cause serious health risk and in severe instances may result in death. This risk is especially high when a mask is worn during exercising in which instance sufficient oxygen transfer to the user lungs are vitally important.

The current invention provides for a mask, which may at least partially alleviate some of the aforementioned problems.

### SUMMARY OF THE INVENTION

The invention provides for a mask having at least two compartments, each compartment being in flow communication with either the nose or mouth of a user.

The mask may include a base layer having at least two openings, the first opening to be position over the nose area and the second opening positioned over the mouth area of a user.

Each chamber may be defined by a second layer spanning each opening. In one embodiment of the invention, the second layer spanning each opening may be removably securable over each opening to define a canopy like compartment defining at least one opening within the canopy, the canopy extending at least partially over the nose and mouth area, allowing a user to freely breathe air without the need to inhale or exhale through the second layer.

In a second embodiment of the invention, the second layer may span the entire opening and may be removably securable over each opening so that a user must inhale and exhale through the second layer.

The canopy may be adjustable to manipulate the opening size of the canopy allowing a user to adjust the air intake depending on the application, alternatively allowing a user to eat food and consume a liquid.

The base and second layers may be manufactured from any suitable material and may be washable.

The mask may further include a securing means for securing the mask in position over the face of a user. In a preferred embodiment of the invention, the securing means may be a string, alternatively an elastic band to be securable either to the ears, alternatively the neck and head area of a user.

In another embodiment of the invention, the base layer may consist of a memory fabric, allowing a user to initially shape the mask to his or her face profile for easy and comfortable wear.

The second layer may be secureable to the first layer by means of clips, alternatively an adhesive material such as Velcro (trade name).

The second layer may further consist of a memory fabric, allowing a user to shape the opening, alternatively the canopy height relative to the nose and mouth for comfort. The second layer may further include an adjustable wire, which may be adjustable to manipulate the opening of the second layer.

### BRIEF DESCRIPTION OF THE DRAWINGS

The invention is now further described by way of example with reference to the accompanying drawings wherein:

FIG. 1 is a plan view of a first layer of a mask according to the invention;

FIG. 2 is a plan view of a second layer imposed on the first layer according to FIG. 1;

FIG. 3 is a side view of the mark according to FIG. 2.

FIG. 4 is a side view of another embodiment of the invention; and

FIG. 5 is a plan view of the mask according to FIG. 4.

### DESCRIPTION OF PREFERRED EMBODIMENTS

In the following embodiments individual characteristics, given in connection with specific embodiments, may actually be interchanged with other different characteristics that exist in other embodiments.

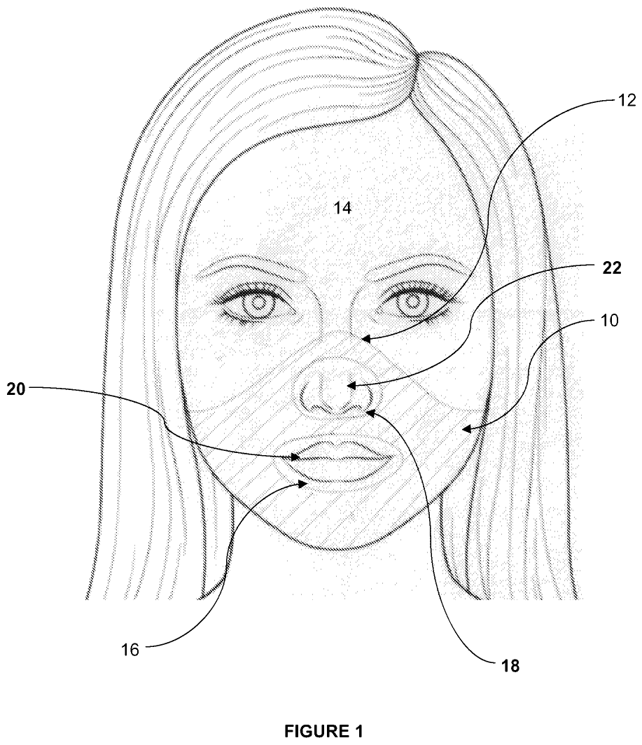

FIG. 1 illustrates a plane view of a base layer (10) of a mask (12) worn by a user (14).

The base layer (10) includes two openings (16) and (18) respectively, which openings (16) and (18) are position over the mouth (20) and nose (22) of the user (14).

Each opening (18) and (16) is shaped to receive and accommodate the relevant body part of the user (14).

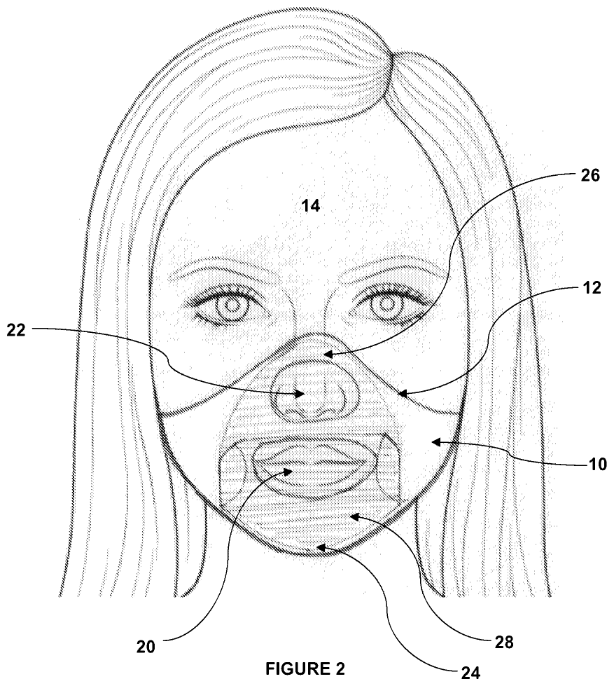

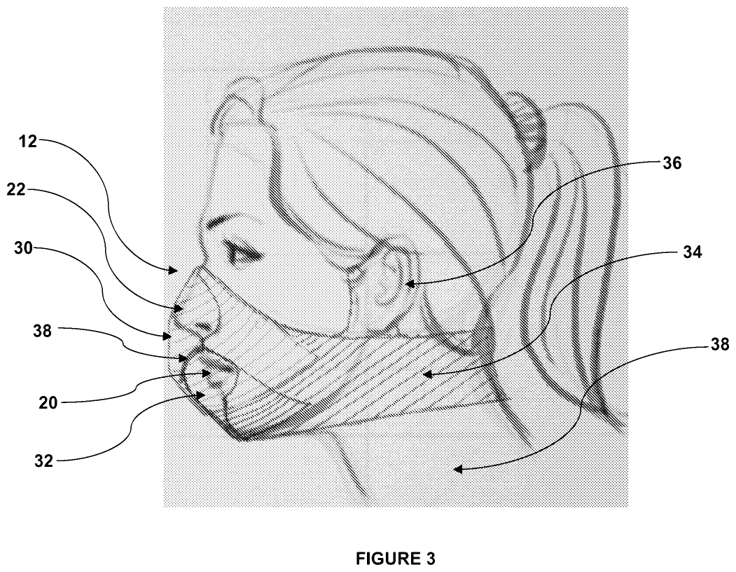

FIG. 2 illustrates the second layer (24) of the mask (12) worn by the user (14). The second layer (24) is shaped and position to define a canopy (26) and (28) extending at least partly over the nose (22) and mouth (20) of the user (14) to define at least two chambers (30) and (32), more clearly illustrated in FIG. 3.

Each chamber (30) and (32) is defined by the second layer (24) spanning each opening (18) and (16).

In one embodiment of the invention, the second layer (24) spanning each opening is removably securable over each opening (18) and (16) to define a canopy like compartment. Each canopy having at least one secondary opening (not shown) within the canopy, allowing the user (14) to freely breeth air without the need to inhale or exhale through the second layer (24). In a preferred embodiment of the invention, the secondary opening (not shown) is pointing downward relative to the user face (14).

In a second embodiment of the invention, the second layer (24) span the entire opening (18) and (16) and is removably securable over each opening so that a user (14) must inhale and exhale through the second layer (24). It will be appreciated that in this embodiment, not secondary opening is provided, which secondary opening is in flow communication with the air.

Each canopy (30) and (32) is adjustable to manipulate the secondary opening size (not shown) of the canopy allowing a user (14) to adjust the air intake depending on the application, alternatively allowing a user (14) to eat food and consume a liquid.

The base (10) and second layers (24) is manufactured form any suitable material and is washable.

The mask (12) also includes a securing means (34) for securing the mask (12) in position over the face of a user (14). In a preferred embodiment of the invention, the securing means (34) is a string, alternatively an elastic band to be securable either to the ears (36), alternatively the neck area (38) of a user (14).

In another embodiment of the invention, the base layer (10) consists of a memory fabric, allowing a user (14) to initially shape the mask to his or her face profile for easy and comfortable wearing.

The second layer (24) is secureable to the base layer (10) by means of clips (not shown), alternatively an adhesive material (not shown) such as Velcro (trade name).

The second layer (24) further consists of a memory fabric, allowing a user (14) to shape the opening, alternatively the canopy height (38) relative to the nose (22) and mouth (20) for comfort. The second layer (24) further includes an adjustable wire (not shown), which may be adjustable to manipulate the opening of the second layer.

It will be appreciated by those skilled in the art that the object of the current invention is to provide a mask having multiple compartments to regulate the intake and discharge of air from a user.

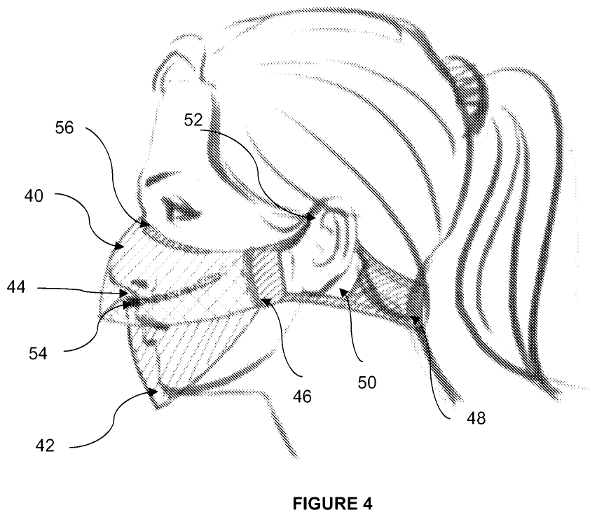

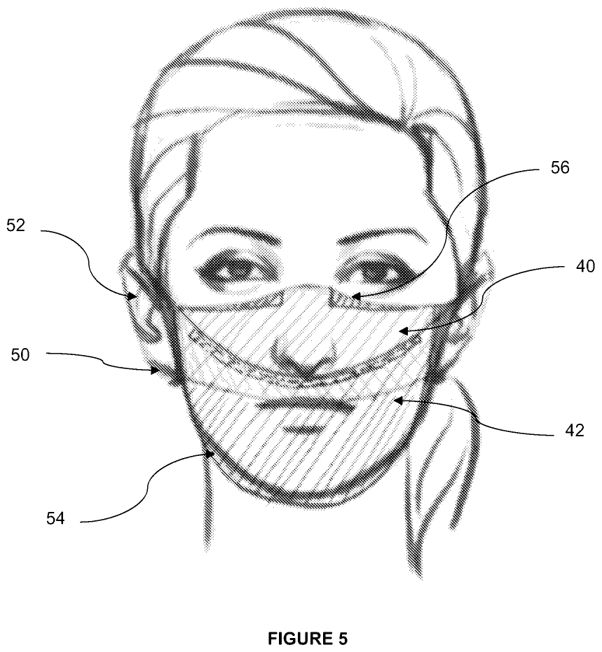

In another embodiment of the invention, as depicted in FIGS. 4 to 5 the mask (10) consists of an upper compartment (40) and a lower compartment (42), both compartments partly overlapping.

Each compartment may consist of three layers of suitable material and in a preferred embodiment, the upper compartments is secured to the lower compartment to define a nose pocket (44) therebetween. A layer generally extends between the upper and lower compartments to enclose the nose pocket (44). The layer may be manufactured from any suitable material and may further include a mesh having a plurality of openings. The openings may allow one directional flow of air.

A layer of material extends between the lower portion of the upper compartment and the upper portion of the lower compartment to define the pocket (44).

In general, does the upper compartment and the lower compartments meet and overlap near the side of the user's face (46) from which a securing means (48) extends. The securing means (48) consists of an elastic material and includes at least two openings (50) through which a user's ears (52) may extend to secure the mask in position.

The securing means (48) also includes a fastening means (not shown) such as Velcro to allow a user to easily secure the mask around his or her neck.

An elastic band (54) is provided which elastic band (54) is securable to the lower compartment and is position to extend between the user's upper lip but below the nose of the user. It will be appreciated that the elastic band will naturally follow the outlines of the user's face to provide a seal between the nose and the mount of the user.

The upper compartment (40) further includes a filing material (56) to follow the outlines of a user's face above the cheeks to ensure a seal between the user's nose and eyes. This is especially beneficial for user's who wears spectacles.

The outer most layer of the mask are manufactured from a fireproof material to protect the face of the user in extreme fire conditions. It will be appreciated that the type of fabric may vary.

In general, the mask layers are manufactured from suitable materials such as hemp, cotton, bamboo and the fire proof materials include Nomex and Pyrotex, This includes the layer of fabric position between the upper and lower compartments.

We claim:

1. A mask having at least two compartments, an upper compartment being in flow communication with the nose and a lower compartment being in flow communication with a mouth of a user, each compartment consists of at least three layers of suitable material and wherein the outermost layer is constructed of a fire proof or retardant material.

2. A mask as claimed in claim 1 wherein each layer of material may act as a filter.

3. A mask as claimed in claim 1 wherein the upper compartment includes a filling material to follow the outlines of a user's face to close the openings define between the mask layers and the face of the user.

4. A mask as claimed in claim 1 wherein the lower compartment includes an elastic band position to extend between a user's upper lips and below the nose to create a seal between the nose and the mouth of a user.

5. A mask as claimed in claim 1 wherein the upper and lower compartments partly overlap, having a filer layer secured between the lower portion of the upper compartment and the upper portion of the lower compartment to define a pocket for the nose.

6. A mask as claimed in claim 5 wherein the filter layer may include a plurality of openings which allow one directional flow of air.

7. A mask as claimed in claim 1 which includes a means for securing the mask in position over a user's ears.

8. A mask as claimed in claim 7 wherein the securing means is an elastic strap having at least two openings define therein and which is securable over a user's ears.

9. A mask as claimed in claim 7 wherein the securing means extends from the upper and lower compartments and around a user's neck, the securing means including a suitable fastening means such, as Velcro, to secure the securing means around a user's neck.
